(19) United States
(12) Patent Application Publication
(10) Pub. No.: US 2025/0193951 A1
(43) Pub. Date: Jun. 12, 2025

(54) TECHNIQUES FOR SIDELINK WIRELESS COMMUNICATION

(71) Applicant: ZTE Corporation, Shenzhen (CN)

(72) Inventors: Mengzhen WANG, Shenzhen (CN); Lin CHEN, Shenzhen (CN); Wanfu XU, Shenzhen (CN); Tao QI, Shenzhen (CN)

(21) Appl. No.: 19/048,630

(22) Filed: Feb. 7, 2025

Related U.S. Application Data
(63) Continuation of application No. PCT/CN2022/110941, filed on Aug. 8, 2022.

(51) Int. Cl. H04W 76/14; H04W 36/00; H04W 76/27; H04W 88/04; H04W 92/18

(52) U.S. Cl. CPC H04W 76/14; H04W 36/033; H04W 76/27; H04W 88/04; H04W 92/18

(57) ABSTRACT

Techniques are described to perform sidelink wireless communication. An example wireless communication method includes receiving, by a first network function of a network device from a second network function of the network device, a request message related to a first communication device, where the request message includes information of a channel to be setup or modified, and where the information includes a second communication device identifier that indicates a second communication device to which the first communication device is configured to setup or modify the channel; and transmitting, by the first network function to the second network function, a response message in response to the receiving the request message.

### CROSS-REFERENCE TO RELATED APPLICATIONS

This application is a continuation of International Patent Application No. PCT/CN2022/110941, filed Aug. 8, 2022, the disclosure of which is incorporated herein by reference in its entirety.

### TECHNICAL FIELD

This document is directed generally to digital wireless communications.

### BACKGROUND

Mobile telecommunication technologies are moving the world toward an increasingly connected and networked society. In comparison with the existing wireless networks, next generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs.

### SUMMARY

Techniques are disclosed for sidelink wireless communication.

A first wireless communication method comprises receiving, by a first network function of a network device from a second network function of the network device, a request message related to a first communication device, where the request message includes information of a channel to be setup or modified, and where the information includes a second communication device identifier that indicates a second communication device to which the first communication device is configured to setup or modify the channel; and transmitting, by the first network function to the second network function, a response message in response to the receiving the request message.

A second wireless communication method comprises transmitting, by a second network function of a network device to a first network function of the network device, a request message that includes information of a channel to be setup or modified, where the information includes a second communication device identifier that indicates a second communication device to which a first communication device is configured to setup or modify the channel. Operation 1004 includes receiving, by the second network function from the first network function, a response message in response to the transmitting the request message.

In some embodiments, the information includes a control plane traffic type that indicates a type of a traffic communicated over the channel is control plane traffic, wherein the control plane traffic type includes an identifier of a sidelink (SL) signaling radio bearer or a priority of the SL signaling radio bearer. In some embodiments, the first communication device includes a source communication device, the request message includes a sidelink (SL) radio bearer to be setup list or modified list that sets up or modifies a communication between the source communication device, a relay communication device, and a target communication device, the source communication device is configured to communicate with the target communication device via the relay communication device, the SL radio bearer to be setup list or modified list includes any one or more of: an identifier associated with a SL radio bearer between the source communication device and the target communication device, and mapping information that indicates a mapping between the identifier of the SL radio bearer and a channel identifier of the channel. In some embodiments, the SL radio bearer includes a SL signaling radio bearer (SRB) or a SL data radio bearer (DRB).

In some embodiments, the first network function receives from the second network function or the second network function transmits to the first network function, a path switch related information that includes one or more of: a path switch indication that instructs a communication device to perform a path switch, or a type of path switch that includes a direct-to-indirect path switch, an indirect-to-direct path switch, or an indirect-to-indirect path switch. In some embodiments, the first communication device includes a source communication device, the first network function receives from the second network function or the second network function transmits to the first network function, a path switch related information that includes: an identifier of a relay communication device, an identifier of a target communication device that indicates a destination to which the source communication device is configured to communicate via the relay communication device. In some embodiments, the first communication device includes a source communication device or a target communication device, and wherein the second communication device includes a relay communication device.

In some embodiments, the first communication device includes a relay communication device, and wherein the second communication device includes a source communication device or a target communication device. In some embodiments, the method further comprises receiving, by the second network function from an access and mobility management function (AMF) of a core network, an authorization information. In some embodiments, the method further comprises transmitting, by the second network function to the first network function or to another base station, the authorization information. In some embodiments, the authorization information includes any one or more of: U2U relay, U2U remote UE, L2 U2U relay, L3 U2U relay, L2 U2U remote UE, or L3 U2U remote UE. In some embodiments, the request message includes a UE context setup request or modification request message, the first network function includes a distributed unit in a base station, the second network function includes a centralized unit in the base station, and/or the channel includes a PC5 radio link control (RLC) channel.

A third wireless communication method includes transmitting, by a first network device to a second network device, a handover request message that triggers a handover of a remote communication device from the first network device to the second network device, where, after the handover, the remote communication device is configured to perform communication with the second network device via a relay communication device; and receiving, by the first network device from the second network device, a response message.

In some embodiments, the handover request message includes a remote communication device capability of the remote communication device to switch to the relay communication device in an idle state or an inactive state. In some embodiments, the second network device is configured to serve a plurality of candidate relay communication devices that includes the relay communication device, and the handover request message includes for each of the plurality of candidate relay communication devices any one or more of: an identifier of a candidate relay communication device, an identifier of a serving cell of the candidate relay communication device, or a link quality between the candidate relay communication device and the remote communication device. In some embodiments, the second network device is configured to select the relay communication device from the plurality of candidate relay communication device, and the response message includes an identifier of the relay communication device.

A fourth wireless communication method includes receiving, by a remote communication device from a source base station, a radio resource control (RRC) reconfiguration message that includes a path switch related information; and performing, by the remote communication device, an uplink data transmission to a target base station via a relay communication device, where the uplink data transmission is performed by switching communication from the source base station to the relay communication device through which the remote communication device is configured to communicate to the target base station.

In some embodiments, the method further comprise transmitting, in response to the receiving the RRC reconfiguration message, a RRC reconfiguration complete message to the relay communication device, where the uplink data transmission is performed in response to the remote communication device receiving an acknowledgement message indicating that the RRC reconfiguration complete message is received by the relay communication device. In some embodiments, the uplink data transmission is performed in response to an expiration of a timer configured by the path switch related information and that is started when the remote communication device receives the path switch related information included in RRC reconfiguration message.

In yet another exemplary aspect, the above-described methods are embodied in the form of processor-executable code and stored in a non-transitory computer-readable storage medium. The code included in the computer readable storage medium when executed by a processor, causes the processor to implement the methods described in this patent document.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWINGS

FIG. 1 shows an example scenario of a sidelink relay wireless communication.

FIG. 2 shows an example diagram of UE-to-UE (U2U) relay communication configuration in centralized unit (CU)-distributed unit (DU) split architecture.

FIGS. 3A-3B show example diagrams of handover procedure for UE-to-network (U2N)path switch.

FIG. 4 shows an example diagram of data transmission during relay user equipment (UE) handover.

FIG. 5 shows an example diagram of remote UE radio resource control (RRC) re-establishment.

FIG. 6 shows an example diagram of inter-gNB indirect-to-direct path switch with dual active protocol stack (DAPS) configured for U2N relay.

FIG. 7 shows an exemplary block diagram of a hardware platform that may be a part of a network device or a communication device.

FIG. 8 shows an example of wireless communication including a base station (BS) and user equipment (UE) based on some implementations of the disclosed technology.

FIG. 9 shows an exemplary flowchart for facilitating sidelink wireless communication.

FIG. 10 shows another exemplary flowchart for facilitating sidelink wireless communication.

FIG. 11 shows an inter-gNB direct-to-indirect path switch with DAPS configured for U2N relay.

FIG. 12 shows an exemplary flowchart for facilitating a handover.

FIG. 13 shows an exemplary flowchart for performing an uplink transmission.

### DETAILED DESCRIPTION

This patent document describes techniques for new radio (NR) side link (SL) relay wireless communication. In some embodiments, techniques are described to solve the SL UE-to-UE relay support in a split architecture, such as a centralized unit (CU)/distributed unit (DU) split architecture. For example, techniques are described for how to configure the PC5 radio link control (RLC) channel and the bearer mapping between end-to-end sidelink radio bearer (SLRB) (including sidelink signaling radio bearer (SL SRB) and sidelink data radio bearer (SL DRB)) and PC5 RLC channel, how to enable the UE-to-UE (U2U) path switch, and/or how to support the authorization for U2U relay. In some other embodiments, techniques are described to provide service continuity for UE-to-network relay, e.g., how to perform inter-gNB direct-to-indirect path switch, how to provide lossless delivery during remote UE RRC re-establishment procedure when relay UE performs handover, and/or the dual active protocol stack (DAPS) impact to UE-to-network (U2N) path switch.

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only, and may be used in wireless systems that implemented other protocols.

### INTRODUCTION

With the development of wireless multimedia services, demands for high data rate and great user experience continuously increase, resulting in higher requirements of the system compacity and coverage of conventional cellular networks. On the other hand, demands for proximity services also increase because of application scenarios such as public security, social network, near-field data sharing and local advertisement. Traditionally, the cellular network using the base station as the center may have obvious limitations on supporting the high data rates and the proximity service. In order to satisfy such requirements, device-to-device (D2D) communication technology is proposed. By applying the D2D communication technology, the burden of the cellular network can be relieved, the power consumption of the user equipment (UE) can be reduced, the data rate can be increased and the robustness of the network infrastructure can be improved. Thus, the demands for high data rate and proximity services are greatly satisfied. In this context, the D2D communication technology is also named proximity services (ProSe) or sidelink (SL) communications, wherein an interface between the UEs is called PC5 interface.

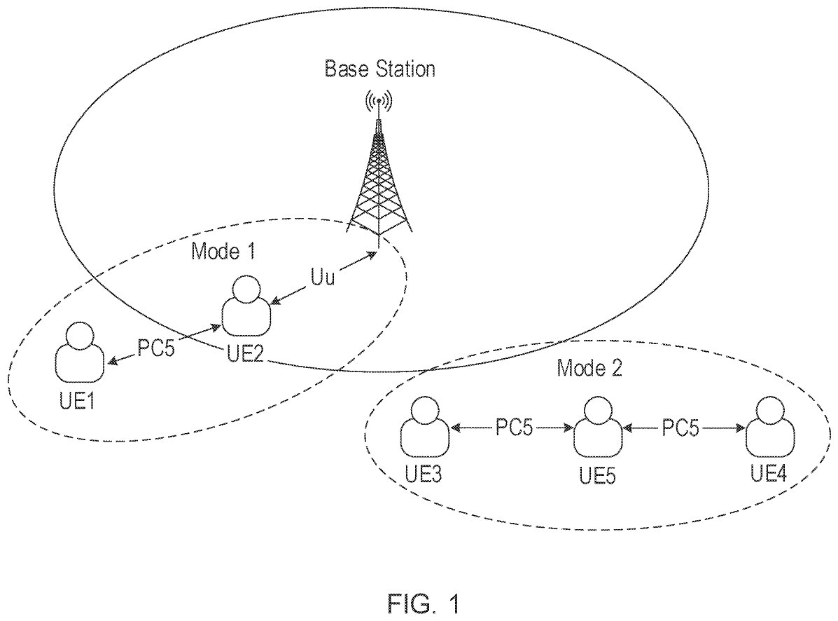

For supporting applications and services in a broader scope (e.g. indoor relay communication, smart agriculture, smart factory, public security, etc.), sidelink-based relay communications may be used to extend the coverage and improve the power consumption. For example, the sidelink-based communications may be applied in two application scenarios shown in FIG. 1:

1) UE-to-Network relay (Pattern 1): This type of relay is used for the UE in a weak/no coverage area. In FIG. 1, a UE1 in the weak/no coverage area is allowed to communicate with the network (e.g. base station) via a UE2 under a coverage of the network. The UE-to-Network relay may help the network operator to extend the coverage and increase the capacity of the network. Note that, in FIG. 1, the UE1 may be called remote UE and the UE2 may be called UE-to-Network relay.

2) UE-to-UE relay (Pattern 2): For an emergency scenario (e.g. an earthquake) of the network working abnormally or for extending a sidelink communication range, the UEs may be allowed to communicate with each other via relay UE(s). For example, UE3 and UE4 in FIG. 1 communicate with each other via a UE5 or multiple relay UEs. The UE5 may be called UE-to-UE (U2U) relay.

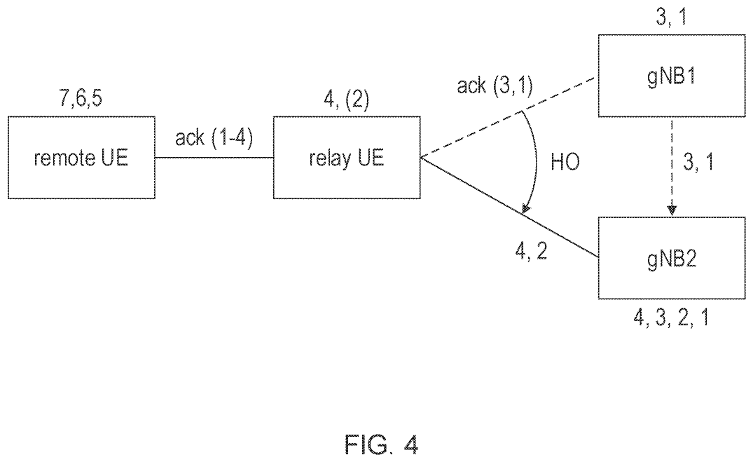

Regarding the U2U relay, a source UE (e.g. UE3 in FIG. 1) may directly communicate with a target UE (e.g. UE4 in FIG. 4) when the source UE and the target UE are within an SL communication range with each other. Due to movements of the source UE and/or the target UE, the source UE may not be able to directly communicate with the target UE and needs to find and search a U2U relay for relaying data between the source UE and the target UE. That is the communication path between the source UE and the target UE may be switched from a direct path to an indirect path (e.g. via a U2U relay). In addition, the communication path between the source UE and the target UE may be switched from the indirect path to the direct path, or from the indirect path to another indirect path (via another U2U relay).

This patent document relates to methods, systems, and devices for sidelink relay communication. The support of UE-to-UE relay in CU/DU split architecture need to be studied, such as the PC5 RLC channel configuration and bearer mapping between SLRB to PC5 RLC channel, the support of authorization and path switch for UE-to-UE relay. In addition, the service continuity for UE-to-Network relay needs to be studied, such as the support of inter-gNB direct-to-indirect path switch, the lossless delivery during remote UE RRC re-establishment, the DAPS impact to U2N path switch.

### I. Embodiment 1: Support L2 U2U Relay in CU-DU Split Architecture

L2 U2U relay is expected to be supported in gNB CU-DU split architecture. The signaling exchange between CU and DU to establish/modify/release PC5 RLC channels for U2U relay UE/remote UE can be considered. A gNB may consist of a gNB-CU and one or more gNB-DU(s). A gNB-CU and a gNB-DU is connected via F1 interface. In some embodiments, one gNB-DU can be connected to only one gNB-CU.

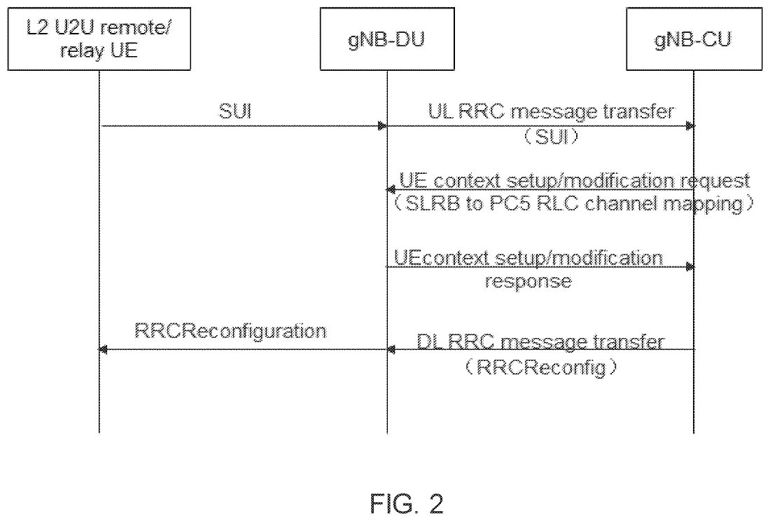

FIG. 2 shows an example diagram of U2U relay communication configuration in CU-DU split architecture. To be specific, after receiving sidelinkUEInformation from U2U remote/relay UE, the gNB-CU can request DU to provide PC5 RLC channel configuration. In the UE context setup/modification request message, CU may include any one or more of SL SRB to be setup list, SL DRB to be setup list, PC5 RLC channel to be setup/modified list. For the SL SRB to be setup list, it may include any one or more of SL SRB ID, SL SRB mapping information. The SL SRB mapping information indicates a mapping between the PC5 RLC channel (identified by PC5 RLC channel ID) and the SL SRB ID of the SL SRB to which the PC5 RLC channel is mapped. The SL DRB to be setup list may include SL DRB mapping information, which indicates a mapping between the PC5 RLC channel (identified by PC5 RLC channel ID) and the SL DRB ID of the SL DRB to which the PC5 RLC channel is mapped. In some embodiments, the PC5 RLC channel ID in the SL SRB mapping information may be the same as the PC5 RLC channel ID in the SL DRB mapping information.

The SL SRB/DRB is the end-to-end SL SRB/DRB between the UE and the peer/destination UE (e.g., end-to-end SL SRB/DRB between the source UE and destination UE). Thus, for example, the SL SRB/DRB is the end-to-end SL SRB/DRB between the source UE and a target UE. The PC5 RLC channel is between source UE and relay UE or between relay UE and target UE.

For the PC5 RLC channel to be setup/modified list, it may include the peer UE ID, which indicates the peer UE that a specific PC5 RLC channel is setup between a UE and a peer UE (e.g., the PC5 RLC channel is to be established between the UE and the peer UE). In some embodiments, the peer UE can refer to a remote UE (e.g., source remote UE or destination/target remote UE). In some embodiments, the peer UE can refer to the relay UE. For example, for the configuration of a U2U remote UE, the peer UE is the U2U relay UE. For the configuration of a U2U relay UE, the peer UE is the source remote UE or destination remote UE. The peer UE ID could be UE L2 ID or UE F1AP ID. If a PC5 RLC channel to be setup/modified list is for transmission of end-to-end SL control plane traffic (SL SRB), a control plane traffic type indication may be included to indicate the type of SL SRB (e.g. identified by SL SRB ID or the priority of the SL SRB) conveyed via the PC5 RLC channel. Otherwise, if a PC5 RLC channel is for transmission of end-to-end SL data, the PC5 QoS of the PC5 RLC channel may be included, wherein the PC5 QoS is referred to PC5 QoS parameters specified for sidelink data transmission. For the PDB (packet delay budget) in the PC5 QoS parameters associated to the PC5 RLC channel, it defines the upper bound for the time that a packet may be delayed between a L2 U2U remote UE and a L2 U2U relay UE.

Considering the path switching between direct path (direct PC5 link between source remote UE and destination remote UE) and indirect path (source remote UE and destination remote UE communicate via a U2U relay UE) or path switching between indirect paths (change from an U2U relay UE to another U2U relay UE), since the path switch configuration is carried in cellGroupConfig generated by gNB-DU, gNB-CU can provide the path switch related information to gNB-DU, wherein the path switch related information includes any one or more of: path switch indication (indicates a direct-to-indirect or indirect-to-direct or indirect-to-indirect path switch), target relay UE ID (indicates the selected target U2U relay UE), peer/destination UE ID (indicates the selected target relay UE is for the path destined to the peer UE), path switch timer. In some embodiments, the path switch related information can be transmitted by the gNB-CU to the gNB-DU via the UE context setup/modification request. In some embodiments, the path switch related information can be transmitted by the gNB-CU to the gNB-DU using another message. A path switch indication can be transmitted by the gNB to the UE, where the path switch indication can indicate to the UE to switch from a direct connection to an indirect connection (direct-to-indirect path switch indication), or from an indirect connection to a direct connection (indirect-to-direct path switch indication), or from an indirection connection to another indirect connection (indirect-to-indirect path switch indication). A direct connection indicates that a source remote UE can communicate with a target remote UE without a relay UE in between the two UEs, and an indirect connection indicates that a source remote UE can communicate with a target remote UE via a relay UE in between the two UEs.

### II. Embodiment 2: L2 U2N Relay Inter-gNB Direct-to-Indirect Path Switch

Inter-gNB direct-to-indirect path switch is supported for L2 U2N relay, in which a L2 remote UE connecting to a source gNB via direct Uu link is switching to an indirect path via a L2 U2N relay UE whose serving gNB (target gNB) is different from the source gNB. The target L2 U2N relay UE may be selected by the source gNB or the target gNB.

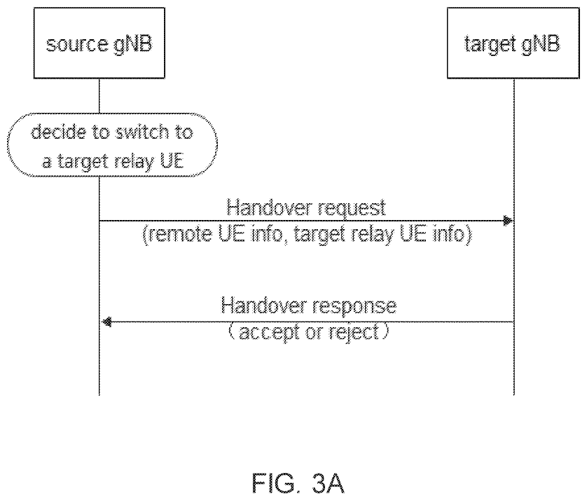

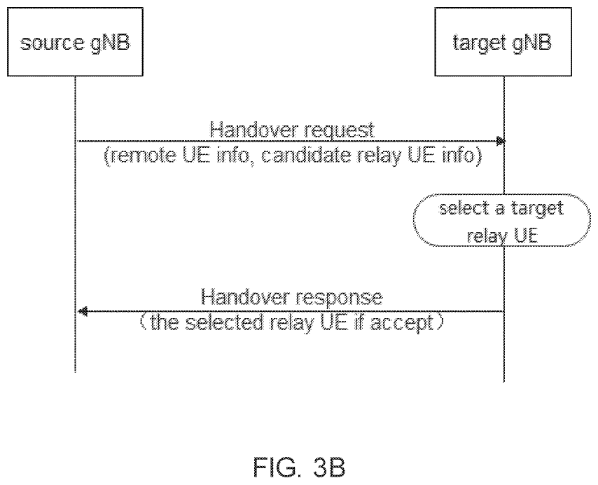

FIG. 3A shows an example diagram of handover procedure for U2N path switch. Upon receiving information of one or multiple candidate relay UEs (candidate relay UE ID, the serving cell ID or new radio cell global identity (NCGI) of the serving cell of the candidate relay UE, the PC5 link quality of the candidate relay UE) from the L2 remote UE, the source gNB may decide to switch the remote UE to a U2N relay UE served by another gNB. The source gNB can recognize the candidate relay UE's serving gNB by the serving cell info of the candidate relay UE reported by remote UE. The source gNB sends handover request message to the serving gNB of the selected relay UE, which may include the remote UE information and the selected target relay UE information. Since the source gNB has no idea of the RRC state of the candidate relay UE when selecting the target relay UE, it can provide the remote UE capability of switching to RRC idle/inactive relay UE to the target relay UE's gNB for the target relay UE's gNB to decide whether to accept the handover request. Thus, the remote UE information may include the remote UE capability of switching to a RRC idle/inactive relay UE. Alternatively, the remote UE capability of switching to a RRC idle/inactive relay UE may be included in sidelinkUEInformation in RRC context in handover request message. After receiving the handover request message, if the target relay UE's gNB identify the target relay UE is in RRC inactive/idle state, and if the remote UE capability indicates not to support to switch to RRC idle/inactive relay UE (or the UE capability of supporting to switch to RRC idle/inactive relay UE is absent in handover request), the target relay UE's gNB may reject the handover request.

FIG. 3B shows another example diagram of handover procedure for U2N path switch In another case, as shown in FIG. 3B, after receiving the reporting from remote UE, if the source gNB identify there are multiple candidate relay UEs served by a same gNB (gNB2 or target gNB shown in FIG. 3B), the source gNB may include the information (e.g., candidate relay UE ID, the serving cell ID or NCGI of the serving cell of the candidate relay UE, the PC5 link quality of the candidate relay UE) of multiple candidate relay UEs (served by gNB2 (e.g., target gNB)) as well as remote UE capability in handover request message to send to gNB2. And the gNB2 may select a target relay UE among these candidate relay UEs and include the target relay UE ID in handover response message to send to the source gNB.

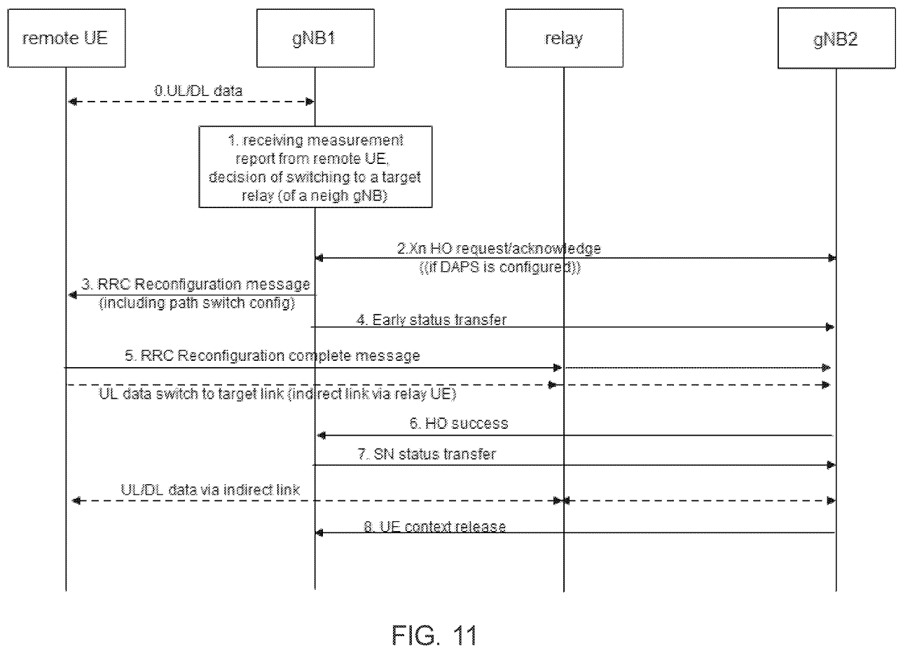

FIG. 11 shows an inter-gNB direct-to-indirect path switch with DAPS configured for U2N relay. If DAPS is configured for remote UE's DRB(s) by the target gNB2, the UL/DL transmission can be continued in original path until it is released by explicit indicating from target node. In legacy, The UE transmits UL data to the source gNB until the random access procedure toward the target gNB has been successfully completed. Afterwards the UE switches its UL data transmission to the target gNB.

However, in the U2N relay case, when remote UE performs path switch to indirect/relay path, there is no random access procedure toward the target gNB. Instead, after receiving RRC reconfiguration with path switch configuration from source gNB (step 3), remote UE initiates PC5 unicast link setup with the target relay UE as indicated in path switch configuration (between step 3 and 5, this step is not drew in the following figure). Then remote UE sends the RRC reconfiguration complete message via PC5 RLC channel to relay UE, and relay UE forwards this message to gNB2 via Uu RLC channel. When relay UE successfully received the remote UE's RRC reconfiguration complete message, the relay UE can send the RLC ack to remote UE. Upon receiving the RLC ack for the RRC reconfiguration complete message from relay UE, remote UE can switch its UL data transmission to relay/indirect link. Or if the remote UE determines that the path switch timer T420 (configured in path switch configuration) has stopped, then remote UE switches its UL data transmission to relay/indirect link. The path switch timer T420 is started when remote UE receiving the path switch configuration included in RRC reconfiguration message.

When target gNB2 receives remote UE's RRC reconfiguration complete message, it sends the HO success message to the source gNB1 to inform the gNB1 that the remote UE has successfully handed over to gNB2.

### III. Embodiment 3: Remote UE RRC Re-Establishment Due to Relay UE Handover

When U2N relay UE performs Uu handover (e.g., receiving reconfigurationWithSync in RRC Reconfiguration), it may send PC5-S release message or PC5 notification message indicating Uu handover (HO) to its connected remote UE(s). When receiving the PC5 notification message indicating Uu HO, the RRC connected remote UE may select to keep the PC5 connection with the current relay UE and initiate RRC re-establishment towards the relay UE's target gNB.

When relay UE receiving HO command, it may stop to forward remote UE's UL data to gNB1. Then when relay UE handed over to gNB2, its buffer may store some remote UE's packets 1) which have been acknowledged to remote UE but have not sent to gNB1 (e.g. packet 4), 2) which have been sent to gNB1 but have not received RLC ack from gNB1 (e.g. packet 2). In legacy (or current technology), after remote UE completes RRC re-establishment with gNB2, the source gNB1 may forward buffered remote UE's data to gNB2 (packet 1, 3) while the buffered remote UE's data at relay UE (packet 2, 4) may be lost from gNB2's point.

To ensure lossless delivery of remote UE's UL data, after remote UE completes RRC re-establishment with gNB2 via relay UE, relay UE could continue forward buffered remote UE's UL data to gNB2.

FIG. 4 shows an example diagram of data transmission during relay UE handover.

Specifically, after the relay UE completes RAN handover (e.g., sends RRC Reconfiguration complete message to target gNB2), relay UE may forward remote UE's RRC Re-establishment request message to target gNB2. When gNB2 sending RRC re-establishment message to remote UE or receiving RRC re-establishment complete message from remote UE, gNB2 may send RRC reconfiguration to relay UE with Uu RLC channel configuration for relay UE to forward remote UE's data. In specific, the RRC reconfiguration message may include any one or more of: remote UE L2 ID, remote UE local ID, Uu RLC channel configuration, PC5 RLC channel configuration, bearer mapping (between remote UE Uu SRB/DRB and relay UE Uu/PC5 RLC channel), data forwarding indication (indicates the relay UE to forward buffered remote UE's data to gNB2 via configured Uu RLC channel).

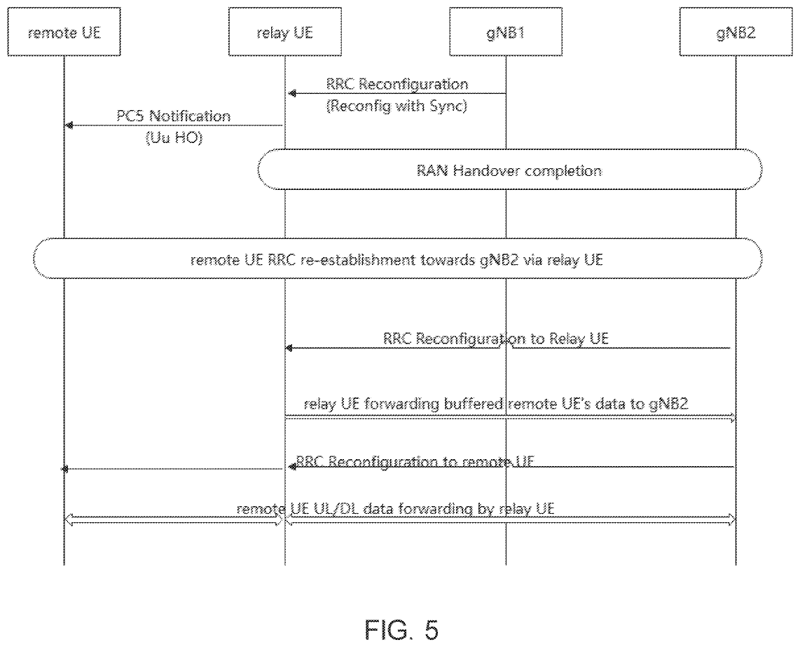

FIG. 5 shows an example diagram of remote UE RRC re-establishment.

After receiving the configuration from gNB2, relay UE may retransmits/transmits from the first packet that has not been successfully acknowledged by lower layer/RLC in the original link (e.g. from packet 2) and excludes the packets that have been successfully confirmed by the lower layer (e.g. excluding packet 3) to gNB2 via configured Uu RLC channel. In addition, relay UE may send an end marker to gNB2 when such buffered data are transmitted to gNB2 and/or before new data received from remote UE. (e.g. the end marker is send after packet 4 and before packet 5.)

If the local ID of the remote UE is updated in the RRC Reconfiguration received by the relay UE from gNB2, e.g., gNB2 assigns a new local ID for remote UE which is different from the local ID assigned by gNB1 (for example, after gNB2 obtains the context information of the remote UE from gNB1, it finds that the local ID of the remote UE assigned by gNB1 conflicts with another remote UE's local ID assigned to gNB2. As a result, gNB2 reassigns the local ID of the remote UE.), there may be a gap about remote UE local ID when forwarding remote UE's data. There are two ways to solve this issue.
Option 1: Relay UE repackages the packets with SRAP headers containing new local ID before forwarding them. Specifically, SRAP headers of the buffered remote UE's packets containing the original local ID assigned by gNB1, if the local ID is updated, relay UE can remove the original SRAP headers and reconstruct the SRAP headers with new local ID and corresponding bearer ID.
Option 2: Based on gNB2 implementation. Relay UE forwards buffered remote UE's packets with the original local ID in SRAP header. after receiving them, gNB2 identifies the data belonging to the remote UE based on the mapping of the original local ID and new local ID.

For gNB2 to parse the data forwarded by relay UE correctly, gNB1 may send its security key (e.g. gNB key of gNB1, key for user data) to gNB2. And gNB2 uses the key form gNB1 to parse the data forwarded by relay UE. Alternatively, gNB2 may send the data forwarded by relay UE to gNB1, gNB1 parses these data and sends the parsed PDCP PDUs to gNB2.

### IV. Embodiment 4: DAPS Impact to U2N Path Switch

DAPS may be configured for remote UE during L2 U2N relay path switch procedure, the DAPS impact can be considered.

In legacy HO, for DRBs configured with DAPS, the UL/DL transmission can be continued in original path until it is released by explicit indicating from target node. Source gNB sends early status transfer message to target gNB. The DL COUNT value conveyed in the EARLY STATUS TRANSFER message indicates PDCP SN and HFN of the first PDCP SDU that the source gNB forwards to the target gNB. The source gNB may additionally send the EARLY STATUS TRANSFER message(s) including DISCARD DL COUNT value to inform discarding of already forwarded PDCP SDUs. The target gNB does not transmit forwarded downlink PDCP SDUs to the UE, whose COUNT is less than the conveyed DL COUNT value and discards them.

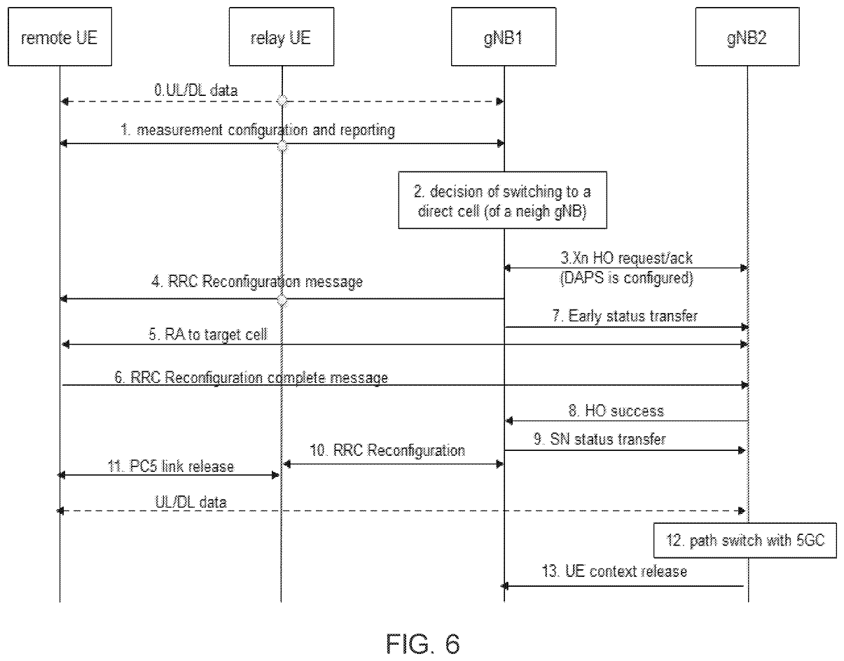

FIG. 6 shows an example diagram of inter-gNB indirect-to-direct path switch with DAPS configured for U2N relay.

When it comes to L2 U2N relay inter-gNB indirect-to-direct path switch, if DAPS is configured for remote UE (in step 3), for the original indirect link (remote UE<-> relay UE<-> gNB1) to continue to serve the remote UE, the indirect/relay link can be maintained at least until the remote UE successfully access to target gNB. That is, the RRC reconfiguration for relay UE (step 10) to release remote UE related configuration can be performed after receiving handover success message from target gNB (step 8).

In legacy, the source gNB determine the discard DL count value in early status transfer message based on lower layer/RLC acknowledgement. However, in U2N relay path switch case, in the original indirect link, the RLC ack from relay UE is not equal to the receiving status of remote UE, e.g. there may be some remote UE's DL packets buffered at relay UE and may be lost. To ensure service continuity and lossless delivery:
Opt 1: the source gNB determines Discard DL count value based on the receiving status of the remote UE (e.g. indicated by PDCP status report or relay UE). The receiving status of the remote UE could be indicated by relay UE, e.g. the relay UE sends the PDCP SN that successfully confirmed by remote UE (based on PC5 RLC ack from remote UE).
Opt 2: After receiving the discard DL count value from gNB1, gNB2 does not discard the packets immediately. Instead, after receiving the PDCP status report from the remote UE, gNB2 determines whether to discard the packets without retransmitting them.

In Opt 1, The source gNB may not be able to obtain the receiving status of the remote UE as fast as the RLC ACK update of the relay UE, which may lead to the repeated transmission of some unnecessary retransmitted packets at gNB2.

### V. Embodiment 5: U2U Authorization

To support L2/L3 UE-to-UE relay communication, gNB may provide SL configuration for RRC connected U2U relay/remote UE. Before providing SL configuration, gNB can check whether the UE is authorized to act as a L2/L3 U2U relay UE or remote UE, or whether the UE is authorized to use L2/L3 U2U relay service/communication. For UE authorization check at gNB, the core network (e.g. access and mobility management function (AMF)) may provide UE authorization information to gNB. In addition, during Handover procedure, the source gNB may provide UE authorization information to the target gNB, or the AMF may provide the UE authorization to the target gNB. In gNB-CU/DU split architecture, since SL resource is configured be gNB-DU, gNB-CU can provide UE authorization information to gNB-DU. The UE authorization may include any one or more of: U2U relay (indicates whether the UE is authorized for/to act as U2U relay), U2U remote UE (indicates whether the UE is authorized for/to act as U2U remote UE), L2 U2U relay (indicates whether the UE is authorized for/to act as L2 U2U relay), L3 U2U relay (indicates whether the UE is authorized for/to act as L3 U2U relay), L2 U2U remote UE (indicates whether the UE is authorized for/to act as L2 U2U remote UE), L3 U2U remote UE (indicates whether the UE is authorized for/to act as L3 U2U remote UE).

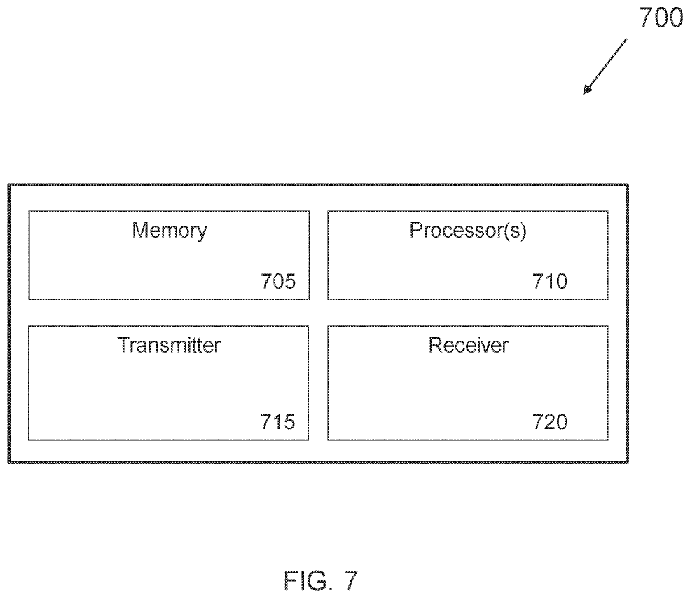

FIG. 7 shows an exemplary block diagram of a hardware platform 700 that may be a part of a network device (e.g., base station) or a communication device (e.g., a user equipment (UE)). The hardware platform 700 includes at least one processor 710 and a memory 705 having instructions stored thereupon. The instructions upon execution by the processor 710 configure the hardware platform 700 to perform the operations described in FIGS. 1 to 6 and 8 to 13 and in the various embodiments described in this patent document. The transmitter 715 transmits or sends information or data to another device. For example, a network device transmitter can send a message to a user equipment. The receiver 720 receives information or data transmitted or sent by another device. For example, a user equipment can receive a message from a network device.

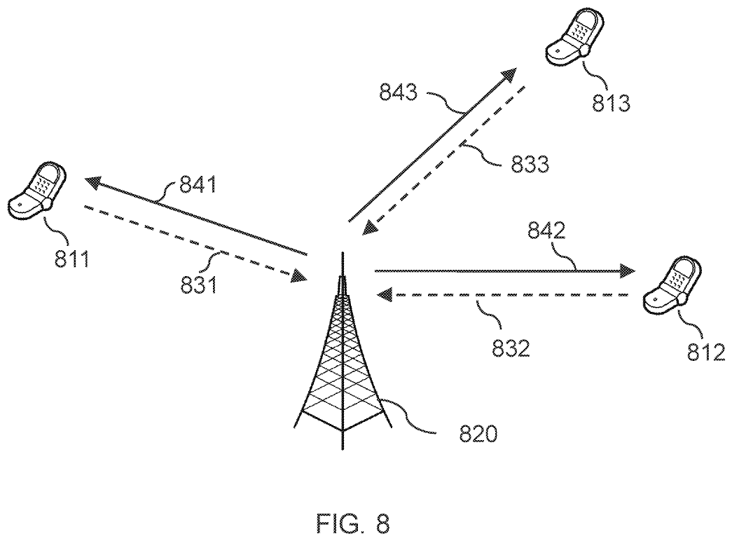

The implementations as discussed above will apply to a wireless communication. FIG. 8 shows an example of a wireless communication system (e.g., a 5G or NR cellular network) that includes a base station 820 and one or more user equipment (UE) 811, 812 and 813. In some embodiments, the UEs access the BS (e.g., the network) using a communication link to the network (sometimes called uplink direction, as depicted by dashed arrows 831, 832, 833), which then enables subsequent communication (e.g., shown in the direction from the network to the UEs, sometimes called downlink direction, shown by arrows 841, 842, 843) from the BS to the UEs. In some embodiments, the BS send information to the UEs (sometimes called downlink direction, as depicted by arrows 841, 842, 843), which then enables subsequent communication (e.g., shown in the direction from the UEs to the BS, sometimes called uplink direction, shown by dashed arrows 831, 832, 833) from the UEs to the BS. The UE may be, for example, a smartphone, a tablet, a mobile computer, a machine to machine (M2M) device, an Internet of Things (IoT) device, and so on.

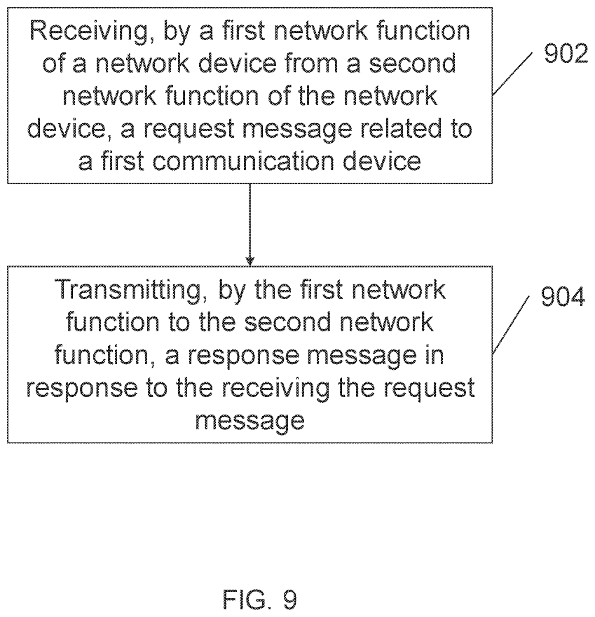

FIG. 9 shows an exemplary flowchart for facilitating sidelink wireless communication. Operation 902 includes receiving, by a first network function of a network device from a second network function of the network device, a request message related to a first communication device, where the request message includes information of a channel to be setup or modified, and where the information includes a second communication device identifier that indicates a second communication device to which the first communication device is configured to setup or modify the channel. Operation 904 includes transmitting, by the first network function to the second network function, a response message in response to the receiving the request message.

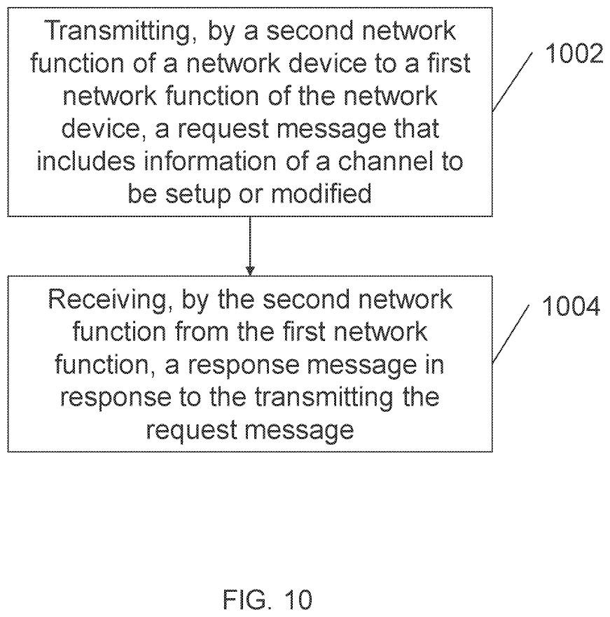

FIG. 10 shows another exemplary flowchart for facilitating sidelink wireless communication. Operation 1002 includes transmitting, by a second network function of a network device to a first network function of the network device, a request message that includes information of a channel to be setup or modified, where the information includes a second communication device identifier that indicates a second communication device to which a first communication device is configured to setup or modify the channel. Operation 1004 includes receiving, by the second network function from the first network function, a response message in response to the transmitting the request message.

In some embodiments, the information includes a control plane traffic type that indicates a type of a traffic communicated over the channel is control plane traffic, wherein the control plane traffic type includes an identifier of a sidelink (SL) signaling radio bearer or a priority of the SL signaling radio bearer. In some embodiments, the first communication device includes a source communication device, the request message includes a sidelink (SL) radio bearer to be setup list or modified list that sets up or modifies a communication between the source communication device, a relay communication device, and a target communication device, the source communication device is configured to communicate with the target communication device via the relay communication device, the SL radio bearer to be setup list or modified list includes any one or more of: an identifier associated with a SL radio bearer between the source communication device and the target communication device, and mapping information that indicates a mapping between the identifier of the SL radio bearer and a channel identifier of the channel. In some embodiments, the SL radio bearer includes a SL signaling radio bearer (SRB) or a SL data radio bearer (DRB).

In some embodiments, the first network function receives from the second network function or the second network function transmits to the first network function, a path switch related information that includes one or more of: a path switch indication that instructs a communication device to perform a path switch, or a type of path switch that includes a direct-to-indirect path switch, an indirect-to-direct path switch, or an indirect-to-indirect path switch. In some embodiments, the first communication device includes a source communication device, the first network function receives from the second network function or the second network function transmits to the first network function, a path switch related information that includes: an identifier of a relay communication device, an identifier of a target communication device that indicates a destination to which the source communication device is configured to communicate via the relay communication device. In some embodiments, the first communication device includes a source communication device or a target communication device, and wherein the second communication device includes a relay communication device.

In some embodiments, the first communication device includes a relay communication device, and wherein the second communication device includes a source communication device or a target communication device, In some embodiments, the method further comprises receiving, by the second network function from an access and mobility management function (AMF) of a core network, an authorization information. In some embodiments, the method further comprises transmitting, by the second network function to the first network function or to another base station, the authorization information. In some embodiments, the authorization information includes any one or more of: U2U relay, U2U remote UE, L2 U2U relay, L3 U2U relay, L2 U2U remote UE, or L3 U2U remote UE. In some embodiments, the request message includes a UE context setup request or modification request message, the first network function includes a distributed unit in a base station, the second network function includes a centralized unit in the base station, and/or the channel includes a PC5 radio link control (RLC) channel.

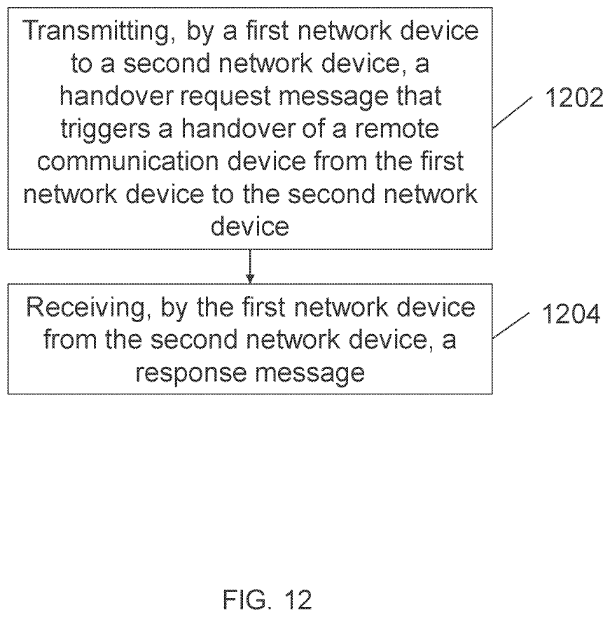

FIG. 12 shows an exemplary flowchart for facilitating a handover. Operation 1202 includes transmitting, by a first network device to a second network device, a handover request message that triggers a handover of a remote communication device from the first network device to the second network device, where, after the handover, the remote communication device is configured to perform communication with the second network device via a relay communication device. Operation 1204 includes receiving, by the first network device from the second network device, a response message.

In some embodiments, the handover request message includes a remote communication device capability of the remote communication device to switch to the relay communication device in an idle state or an inactive state. In some embodiments, the second network device is configured to serve a plurality of candidate relay communication devices that includes the relay communication device, and the handover request message includes for each of the plurality of candidate relay communication devices any one or more of: an identifier of a candidate relay communication device, an identifier of a serving cell of the candidate relay communication device, or a link quality between the candidate relay communication device and the remote communication device. In some embodiments, the second network device is configured to select the relay communication device from the plurality of candidate relay communication device, and the response message includes an identifier of the relay communication device.

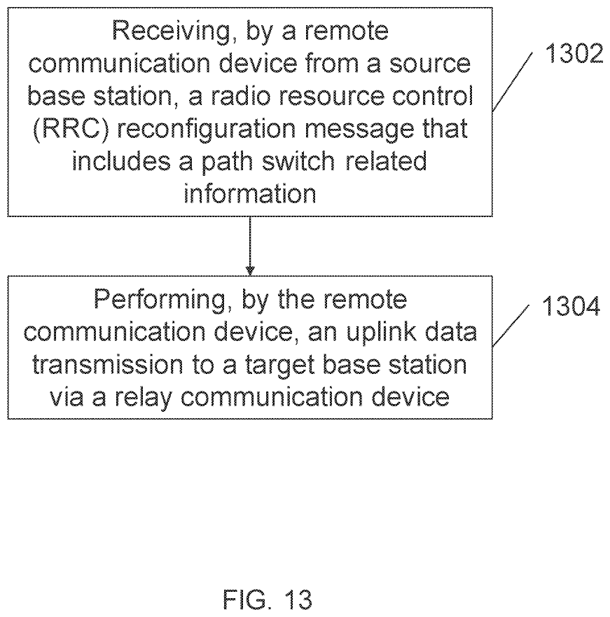

FIG. 13 shows an exemplary flowchart for performing an uplink transmission. Operation 1302 includes receiving, by a remote communication device from a source base station, a radio resource control (RRC) reconfiguration message that includes a path switch related information. Operation 1304 includes performing, by the remote communication device, an uplink data transmission to a target base station via a relay communication device, where the uplink data transmission is performed by switching communication from the source base station to the relay communication device through which the remote communication device is configured to communicate to the target base station.

In some embodiments, the method further comprise transmitting, in response to the receiving the RRC reconfiguration message, a RRC reconfiguration complete message to the relay communication device, where the uplink data transmission is performed in response to the remote communication device receiving an acknowledgement message indicating that the RRC reconfiguration complete message is received by the relay communication device. In some embodiments, the uplink data transmission is performed in response to an expiration of a timer configured by the path switch related information and that is started when the remote communication device receives the path switch related information included in RRC reconfiguration message.

In this document the term “exemplary” is used to mean “an example of” and, unless otherwise stated, does not imply an ideal or a preferred embodiment.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

I/We claim:

1. A wireless communication method, comprising:
receiving, by a first network function of a network device from a second network function of the network device, a request message related to a first communication device,
wherein the request message includes information of a channel to be setup or modified, and
wherein the information includes a second communication device identifier that indicates a second communication device to which the first communication device is configured to setup or modify the channel; and
transmitting, by the first network function to the second network function, a response message in response to the receiving the request message.

2. The method of claim 1, wherein the information includes a control plane traffic type that indicates a type of a traffic communicated over the channel is control plane traffic, wherein the control plane traffic type includes an identifier of a sidelink (SL) signaling radio bearer or a priority of the SL signaling radio bearer.

3. The method of claim 1,
wherein the first communication device includes a source communication device,
wherein the request message includes a sidelink (SL) radio bearer to be setup list or modified list that sets up or modifies a communication between the source communication device, a relay communication device, and a target communication device,
wherein the source communication device is configured to communicate with the target communication device via the relay communication device,
wherein the SL radio bearer to be setup list or modified list includes any one or more of:
an identifier associated with a SL radio bearer between the source communication device and the target communication device, and
mapping information that indicates a mapping between the identifier of the SL radio bearer and a channel identifier of the channel.

4. The method of claim 3, wherein the SL radio bearer includes a SL signaling radio bearer (SRB) or a SL data radio bearer (DRB).

5. The method of claim 1, wherein the first network function receives from the second network function or the second network function transmits to the first network function, a path switch related information that includes one or more of:
a path switch indication that instructs a communication device to perform a path switch, or
a type of path switch that includes a direct-to-indirect path switch, an indirect-to-direct path switch, or an indirect-to-indirect path switch.

6. The method of claim 1,
wherein the first communication device includes a source communication device,
wherein the first network function receives from the second network function or the second network function transmits to the first network function, a path switch related information that includes:
an identifier of a relay communication device, an identifier of a target communication device that indicates a destination to which the source communication device is configured to communicate via the relay communication device.

7. The method of claim 1, wherein the first communication device includes a source communication device or a target communication device, and wherein the second communication device includes a relay communication device.

8. The method of claim 1, wherein the first communication device includes a relay communication device, and wherein the second communication device includes a source communication device or a target communication device.

9. The method of claim 1,
wherein the request message includes a UE context setup request or modification request message,
wherein the first network function includes a distributed unit in a base station,
wherein the second network function includes a centralized unit in the base station, and/or
wherein the channel includes a PC5 radio link control (RLC) channel.

10. A wireless communication method, comprising:
transmitting, by a second network function of a network device to a first network function of the network device, a request message that includes information of a channel to be setup or modified,
wherein the information includes a second communication device identifier that indicates a second communication device to which a first communication device is configured to setup or modify the channel; and
receiving, by the second network function from the first network function, a response message in response to the transmitting the request message.

11. The method of claim 10, further comprising:
receiving, by the second network function from an access and mobility management function (AMF) of a core network, an authorization information.

12. The method of claim 11, further comprising:
transmitting, by the second network function to the first network function or to another base station, the authorization information.

13. The method of claim 11, wherein the authorization information includes any one or more of: U2U relay, U2U remote UE, L2 U2U relay, L3 U2U relay, L2 U2U remote UE, or L3 U2U remote UE.

14. A wireless communication method, comprising:
transmitting, by a first network device to a second network device, a handover request message that triggers a handover of a remote communication device from the first network device to the second network device,
wherein, after the handover, the remote communication device is configured to perform communication with the second network device via a relay communication device; and
receiving, by the first network device from the second network device, a response message.

15. The method of claim 14, wherein the handover request message includes a remote communication device capability of the remote communication device to switch to the relay communication device in an idle state or an inactive state.

16. The method of claim 14,
wherein the second network device is configured to serve a plurality of candidate relay communication devices that includes the relay communication device, and
wherein the handover request message includes for each of the plurality of candidate relay communication devices any one or more of:
an identifier of a candidate relay communication device,
an identifier of a serving cell of the candidate relay communication device, or
a link quality between the candidate relay communication device and the remote communication device.

17. The method of claim 14,
wherein the second network device is configured to select the relay communication device from a plurality of candidate relay communication devices, and
wherein the response message includes an identifier of the relay communication device.

18. A wireless communication method, comprising:
receiving, by a remote communication device from a source base station, a radio resource control (RRC) reconfiguration message that includes a path switch related information; and
performing, by the remote communication device, an uplink data transmission to a target base station via a relay communication device,
wherein the uplink data transmission is performed by switching communication from the source base station to the relay communication device through which the remote communication device is configured to communicate to the target base station.

19. The method of claim 18, further comprising:
transmitting, in response to the receiving the RRC reconfiguration message, a RRC reconfiguration complete message to the relay communication device,
wherein the uplink data transmission is performed in response to the remote communication device receiving an acknowledgement message indicating that the RRC reconfiguration complete message is received by the relay communication device.

20. The method of claim 18, wherein the uplink data transmission is performed in response to an expiration of a timer configured by the path switch related information and that is started when the remote communication device receives the path switch related information included in RRC reconfiguration message.
